(19) United States
(12) Patent Application Publication
(10) Pub. No.: US 2007/0081783 A1
(43) Pub. Date: Apr. 12, 2007

(54) WAVEGUIDE DEVICE FOR PLANAR DISPLAY DEVICE AND RELATED PLANAR DISPLAY DEVICE

(76) Inventors: Jyh-Long Chen, Hsin-Chu City (TW); Sen-Nien Chung, Taipei City (TW); Ming-Der Chou, Taipei City (TW); Yi-Kai Cheng, Tainan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/162,912

(22) Filed: Sep. 28, 2005

(51) Int. Cl. G02B 6/10

(52) U.S. Cl. 385/146

(57) ABSTRACT

A waveguide device used for a planar display device having an image source for emitting modulated light beams and a display panel for displaying an image. The waveguide device includes a slab waveguide having a light entrance plane and a light exit plane, a lens array comprising a plurality of lenses disposed in the form of a matrix for individually tuning and guiding corresponding modulated light beams to desired positions on the light entrance plane of the slab waveguide, a wedge waveguide for receiving modulated light beams emitted from the light exit plane of the slab waveguide and emitting the received modulated light beams to the display panel to form the image, and a fixing device for fixing the wedge waveguide to the slab waveguide.

### BACKGROUND OF THE INVENTION

1. Field of the Invention

The present invention relates to a planar display device, and more particularly, to a waveguide device for a planar display device and related planar display device.

2. Description of the Prior Art

Please refer to FIG. 1, which is a schematic diagram of a planar display device 10 according to the prior art. The planar display device 10 comprises an image source 12, a projection lens 14, a slab waveguide 16, a wedge waveguide 18, a fixing device 20, and a display panel 22.

The image source 12 emits a plurality of modulated light beams disposed in the form of a matrix, the modulated light beams forming an image. The display panel 22 is installed to display the image. The slab waveguide 16 comprises a light entrance plane 24 and a light exit plane 26. The slab waveguide 16 guides the modulated light beams projected onto the light entrance plane 24 to the light exit plane 26, so as to extend the image formed by the modulated light beams. The projection lens 14 is installed to project the image (that is, the modulated light beams) generated by the image source 12 onto the light entrance plane 24 of the slab waveguide 16. The wedge waveguide 18 receives the extended image extended by the slab waveguide 16 (the extended image enters the wedge waveguide 18 via a light entrance plane 28 of the wedge waveguide 18), and, through a reflection effect performed by a wedge plane 30, gradually decreases the incident angles that the modulated light beams enter a plane 32 to form the image on the display panel 22 from bottom to top.

Though the projection lens 14 is capable of projecting all of the modulated light beams emitted from the image source 12 onto the light entrance plane 24 of the slab waveguide 16, it lacks of the capability to project each of the modulated light beams to a desired position on the light entrance plane 24 of the slab waveguide 16. For example, when projecting the modulated light beams onto the light entrance plane 24 of the slab waveguide 16, the projection lens 14 projects modulated light beams disposed in a central region of the image source 12 to a desired position. Therefore, the image displayed on the display panel 22 is distorted.

### SUMMARY OF THE INVENTION

It is therefore a primary objective of the claimed invention to provide a waveguide device for a planar display device and related planar display device to overcome the above-mentioned problems.

The waveguide device includes a slab waveguide having a light entrance plane and a light exit plane opposite to the light entrance plane, a lens array, a wedge waveguide, and a fixing device for fixing the wedge waveguide to the slab waveguide. The lens array consists of a plurality of lens units disposed in the form of a matrix. The lens units correspond to a plurality of modulated light beams emitted by an image source and disposed in the form of a matrix. Each of the lens units is capable of tuning and guiding a corresponding modulated light beam to project onto a predetermined position of the light entrance plane of the slab waveguide. The wedge waveguide has a light entrance plane for receiving modulated light beams emitted from the light exit plane of the slab waveguide, and a light exit plane installed on a side of the display panel for projecting modulated light beams received by the light entrance plane of the wedge waveguide onto a display panel, so as to form the image on the display panel.

The planar display device includes an image source for emitting a plurality of modulated light beams disposed in the form of a matrix, a display panel for displaying an image, a slab waveguide having a light entrance plane and a light exit plane opposite to the light entrance plane, a lens array, a wedge waveguide, and a fixing device for fixing the wedge waveguide to the slab waveguide. The lens array comprises a plurality of lens units corresponding to the modulated light beams and disposed in the form of a matrix. Each of the lens units is capable of tuning and guiding a corresponding modulated light beam to project onto a predetermined position of the light entrance plane of the slab waveguide. The wedge waveguide has a light entrance plane for receiving modulated light beams emitted from the light exit plane of the slab waveguide, and a light exit plane installed on a side of the display panel for projecting modulated light beams received by the light entrance plane of the wedge waveguide onto the display panel, so as to form the image on the display panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a planar display device according to the prior art.

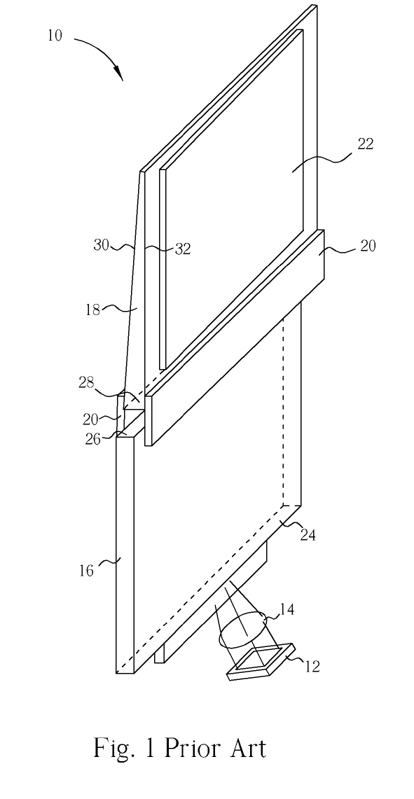

FIG. 2 is a schematic diagram of a planar display device of a first embodiment according to the present invention.

FIG. 3 shows light paths of the planar display device shown in FIG. 2.

FIG. 4 is a schematic diagram of a planar display device of a second embodiment according to the present invention.

FIG. 5 is a schematic diagram of a planar display device of a third embodiment according to the present invention.

### DETAILED DESCRIPTION

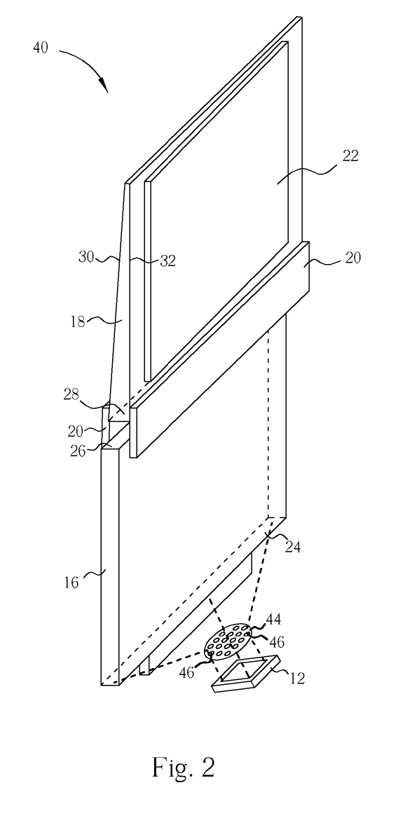

Please refer to FIG. 2, which is a schematic diagram of a planar display device 40 of a first embodiment according to the present invention. In addition to the image source 12, the slab waveguide 16, the wedge waveguide 18, the fixing device 20, and the display panel 22, the planar display device 40 further comprises a lens array 44 for projecting the image (i.e. the modulated light beams) generated by the image source 12 onto the light entrance plane 24 of the slab waveguide 16. The slab waveguide 16, the wedge waveguide 18, the fixing device 20, and the lens array 44 form a waveguide device.

The lens array 44 comprises a plurality of lens units 46 disposed in the form of a matrix and corresponding to the modulated light beams. Each of the lens units 46 is capable of individually tuning and guiding a corresponding modulated light beam onto a predetermined position on the light entrance plane 24 of the slab waveguide 16.

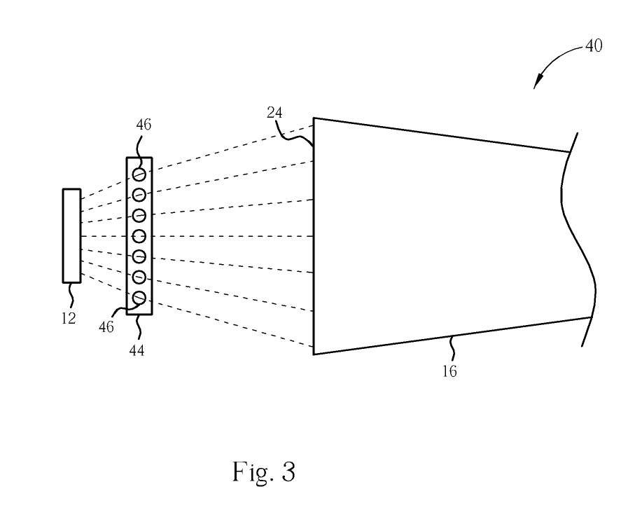

Please refer to FIG. 3, which shows light paths of the planar display device 40. Only the image source 12, the lens array 44 and the slab waveguide 16 of the planar display device 40 are shown in FIG. 3 for simplicity. As shown in FIG. 3, each of the lens units 46 of the lens array 44 has the capability to individually tune and guide a corresponding modulated light beam onto a corresponding predetermined position on the light entrance plane 24 of the slab waveguide 16. Therefore, the image displayed on the display panel 22 is not distorted.

In the first embodiment, the image source 12 comprises a light source for emitting light, and a digital micro-mirror device comprising a plurality of micro mirrors disposed in the form of a matrix for reflecting the light emitted from the light source and forming the modulated light beams. The image source 12 of the planar display device 40 can be a digital light processor (DLP), a liquid crystal display panel (LCD), or a liquid-crystal-on-silicon (LCOS) device.

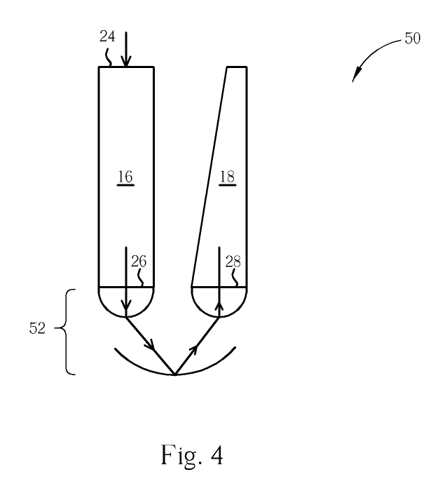

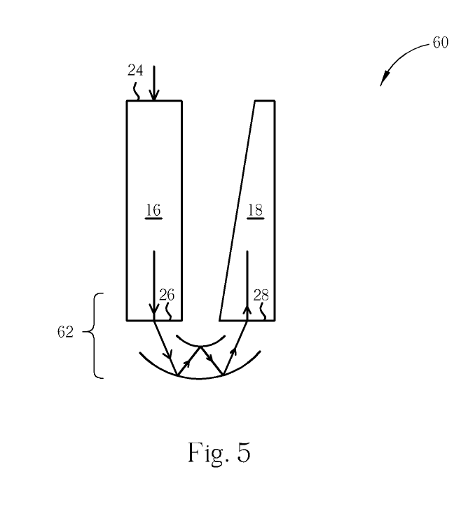

Please refer to FIG. 4 and FIG. 5. FIG. 4 is a side view of a planar display device 50 of a second embodiment according to the present invention. FIG. 5 is a side view of a planar display device 60 of a third embodiment according to the present invention. Different from the planar display device 40, which comprises an end-to-end arrangement of the slab waveguide 16 and wedge waveguide 18 (i.e. the light exit plane 26 of the slab waveguide 16 is designed to face the light entrance plane 28 of the wedge waveguide 18), the planar display device 50 of the second embodiment and the planar display device 60 of the third embodiment further comprise a shoulder-to-shoulder arrangement of the slab waveguide 16 and wedge waveguide 18.

In addition to the slab waveguide 16 and wedge waveguide 18, the planar display device 50 further comprises a Dyson catadioptric system 52, and the planar display device 60 further comprises an Offner catadioptric system 62. Of course, the planar display devices 50 and 60 also comprise the image source 12, the fixing device 20, the display panel 22, and the lens array 44, which are omitted from FIG. 4 and FIG. 5 for clarity.

Both of the Dyson catadioptric system 52 and the Offner catadioptric system 62 are disposed near the light exit plane 26 of the slab waveguide 16 and the light entrance plane 28 of the wedge waveguide 18 for refracting and reflecting the modulated light beams emitted from the light exit plane 26 of the slab waveguide 16, i.e. along arrows shown in FIG. 4 and FIG. 5, to the light entrance plane 28 of the wedge waveguide 18.

Because the slab waveguide 16 is installed shoulder-to-shoulder with the wedge waveguide 18, the planar display devices 50 and 60 have structures more compact than that of the planar display device 40.

In contrast to the prior art, the planar display devices 40, 50, and 60 of the present invention comprise the lens array 44, which comprises the plurality of lens units 46. Because each of the lens units 46 is capable of individually tuning and guiding a corresponding modulated light beam onto a corresponding predetermined position on the light entrance plane 24 of the slab waveguide 16, the image displayed on the display panel 22 is not distorted. Moreover, the installation of the Dyson catadioptric system 52 or the Offner catadioptric system 62 enables the slab waveguide 16 to be located at a region behind the wedge waveguide 18, so that both the planar display device 50 and the planar display device 60 have compact structures.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A waveguide device for a planar display device, the planar display device comprising:
an image source for emitting a plurality of modulated light beams disposed in the form of a matrix; and
a display panel for displaying an image;
the waveguide device comprising:
a slab waveguide comprising a light entrance plane and a light exit plane opposite to the light entrance plane;
a lens array comprising a plurality of lens units corresponding to the modulated light beams and disposed in the form of a matrix, each of the lens units able to tune and guide a corresponding modulated light beam to project onto a predetermined position of the light entrance plane of the slab waveguide;
a wedge waveguide comprising:
a light entrance plane for receiving modulated light beams emitted from the light exit plane of the slab waveguide; and
a light exit plane installed on a side of the display panel for projecting modulated light beams received by the light entrance plane of the wedge waveguide onto the display panel, so as to form the image on the display panel; and
a fixing device for fixing the wedge waveguide to the slab waveguide.

2. The waveguide device of claim 1 further comprising a Dyson catadioptric system installed near the light exit plane of the slab waveguide and the light entrance plane of the wedge waveguide for refracting and reflecting the modulated light beams emitted from the light exit plane of the slab waveguide to the light entrance plane of the wedge waveguide.

3. The waveguide device of claim 1 further comprising an Offner catadioptric system installed near the light exit plane of the slab waveguide and the light entrance plane of the wedge waveguide for refracting and reflecting the modulated light beams emitted from the light exit plane of the slab waveguide to the light entrance plane of the wedge waveguide.

4. A planar display device comprising:
an image source for emitting a plurality of modulated light beams disposed in the form of a matrix;
a display panel for displaying an image;
a slab waveguide comprising a light entrance plane and a light exit plane opposite to the light entrance plane;
a lens array comprising a plurality of lens units corresponding to the modulated light beams and disposed in the form of a matrix, each of the lens units able to tune and guide a corresponding modulated light beam to project onto a predetermined position of the light entrance plane of the slab waveguide;
a wedge waveguide comprising:
a light entrance plane for receiving modulated light beams emitted from the light exit plane of the slab waveguide; and
a light exit plane installed on a side of the display panel for projecting modulated light beams received by the light entrance plane of the wedge waveguide onto the display panel, so as to form the image on the display panel; and
a fixing device for fixing the wedge waveguide to the slab waveguide.

5. The planar display device of claim 4 further comprising a Dyson catadioptric system installed near the light exit plane of the slab waveguide and the light entrance plane of the wedge waveguide for refracting and reflecting the modulated light beams emitted from the light exit plane of the slab waveguide to the light entrance plane of the wedge waveguide.

6. The planar display device of claim 4 further comprising an Offner catadioptric system installed near the light exit plane of the slab waveguide and the light entrance plane of the wedge waveguide for refracting and reflecting the modulated light beams emitted from the light exit plane of the slab waveguide to the light entrance plane of the wedge waveguide.

7. The planar display device of claim 4, wherein the image source comprises:
a light source for emitting light; and
a digital micro-mirror device comprising a plurality of micro-mirrors disposed in the form of a matrix for reflecting the light emitted from the light source and forming the modulated light beams.

8. The planar display device of claim 4, wherein the image source is a digital light processor (DLP).

9. The planar display device of claim 4, wherein the image source is a liquid crystal display (LCD).

10. The planar display device of claim 4, wherein the image source is a liquid-crystal-on-silicon (LCOS) device.
